(19) United States
(12) Patent Application Publication
(10) Pub. No.: US 2008/0311877 A1
(43) Pub. Date: Dec. 18, 2008

(54) DETERMINATION OF WIRE METRIC FOR DELIVERY OF POWER TO A POWERED DEVICE OVER COMMUNICATION CABLING

(75) Inventor: Yair Darshan, Petach Tikva (IL)

Correspondence Address: MICROSEMI CORP - AMSG LTD., C/O LANDONIP, INC, 1700 DIAGONAL ROAD, SUITE 450, ALEXANDRIA, VA, 22202-3709, US

(73) Assignee: POWERDSINE, LTD. - MICROSEMI CORPORATION, Hod Hasharon (IL)

(21) Appl. No.: 11/764,295

(22) Filed: Jun. 18, 2007

(51) Int. Cl. G06F 1/26; H04L 12/44

(52) U.S. Cl. 455/402

(57) ABSTRACT

A method of powering from a power sourcing equipment to a powered device over communication cabling, the method comprising: determining the effective resistance between a power sourcing equipment and a powered device; determining the length of communication cabling between the power sourcing equipment and the powered device; calculating a metric of the constituent wires of the communication cabling between the power sourcing equipment and the powered device responsive to the determined effective resistance and the determined length of communication cabling; and setting current limits for the powering of the powered device from the power sourcing equipment responsive to the calculated metric. In one embodiment the metric is one of a cross-sectional, an effective resistance per unit length and a current carrying capability of the constituent wires.

### BACKGROUND OF THE INVENTION

The invention relates generally to the field of power over local area networks, particularly Ethernet based networks, and more particularly to a method of determining the current limits applicable for powering a powered device over communication cabling.

The growth of local and wide area networks based on Ethernet technology has been an important driver for cabling offices and homes with structured cabling systems having multiple twisted wire pairs. The structured cable is also known herein as communication cabling and typically comprises four twisted wire pairs. In certain networks only two twisted wire pairs are used for communication, with the other set of two twisted wire pairs being known as spare pairs. In other networks all four twisted wire pairs are used for communication. The ubiquitous local area network, and the equipment which operates thereon, has led to a situation where there is often a need to attach a network operated device for which power is to be advantageously supplied by the network over the network wiring. Supplying power over the network wiring has many advantages including, but not limited to: reduced cost of installation; centralized power and power back-up; and centralized security and management.

Several patents addressed to the issue of supplying power to a powered device (PD) over an Ethernet based network exist including: U.S. Pat. No. 6,473,608 issued Oct. 29, 2002 to Lehr et al.; and U.S. Pat. No. 6,643,566 issued Nov. 4, 2003 to Lehr et al.; the contents of each of which are incorporated herein by reference.

The IEEE 802.3af-2003 standard, published by the Institute of Electrical and Electronics Engineers, Inc, N.Y., whose contents are incorporated herein by reference, is addressed to powering remote devices over an Ethernet based network. The above standard is limited to a PD having a maximum power requirement during operation of 12.95 watts. Power can be delivered to the PD either directly from the switch/hub, known as an endpoint power sourcing equipment (PSE), or alternatively via a midspan PSE. In either case power is delivered over a set of two twisted pairs. The above mentioned standard further prescribes a method of classification having a total of 5 power levels of which classes 0, 3 and 4 result in a maximum power level of 15.4 at the PSE which is equivalent, in the worst case, to the aforementioned 12.95 watt limit.

The actual difference between the power level drawn from the PSE and the power level received at the PD is primarily a function of the power lost in the cable. The power required at the PSE to support a particular requested maximum power at the PD is thus equal to the requested maximum PD power plus any losses due to the effective resistance between the PSE and the PD. A maximum cable length of 100 meters is specified, and the voltage supplied by the PSE may range from a minimum of 44 volts to a maximum of 57 volts as measured at the PSE output. Thus, the amount of power lost in the cable may vary significantly depending on actual cable length and actual voltage. The above mentioned standard defines a maximum current level for delivery over the communication cabling, primarily as a result of a limit in allowable temperature rise of the communication cabling caused by power lost due to the cable resistance.

The IEEE 802.3af standard defines, among other parameters, a maximum current at short circuit, denoted I_{LIM}, and an allowable overload current limit, denoted I_{CUT}, the allowable overload current being limited to a predetermined time period, denoted T_{OVLD}, after which power is to be removed from the PD.

The IEEE 802.3at task force is in the process of developing a higher power standard, which is to be backwards compatible with the above mentioned IEEE 802.3af standard. The maximum current capability of the IEEE 802.3at task force is similarly limited by an allowable maximum temperature rise of the communication cabling which is a function of the power dissipated across the conductor.

The maximum allowable current to be supplied over communication cabling is thus constrained by a predetermined maximum allowable temperature rise, which in itself is a function of the cabling type actually used. Thus, the maximum current limitation of IEEE 802.3af is based on category 3 cables, as defined by the TIA/EIA standard TIA/EIA-568-B.1 published by the Telecommunications Industry Association 2001 of Arlington, Va. It is expected that the maximum current limitation of IEEE 802.3at will be based on a minimum of category 5e cables as defined by TIA/EIA-568-B.1, with a concomitant increase in allowable current.

The type of communication cabling commonly installed has changed over the years, exhibiting a trend towards increasing wire thickness. The current limits respectively defined by the above mentioned IEEE 802.3af standard and IEEE 802.3at task force, are however restricted to a predetermined worst case cabling. Thus, in the event of a premises exhibiting cabling with a greater current carrying capacity, no additional current is delivered.

U.S. patent application Ser. No. 11/620,675, filed Jan. 7, 2007 in the name of Admon et al, entitled “Determination of Effective Resistance Between a Power Sourcing Equipment and a Powered Device”, the entire contents of which is incorporated herein by reference, is addressed to a method of determining an effective resistance between a PSE and a PD, the PD exhibiting an interface and an operational circuitry, the method comprising: prior to connecting power to the operational circuitry of the PD, impressing two disparate current flow levels (I₁, I₂) between the PSE and the PD; measuring the voltage at the PD interface (V_{PD1}, V_{PD2}) responsive to each of the impressed disparate current levels; measuring the voltage at the PSE (V_{PSE1}, V_{PSE2}) responsive to each of the impressed disparate current levels; and determining the effective resistance between the PSE and the PD responsive to V_{PD1}, P_{PD2}, V_{PSE1}, V_{PSE2}, I₁ and I₂. However, no provision is made in the above subject patent application for adjusting current levels and limits between the PSE and the PD responsive to the determined effective resistance.

U.S. patent application Ser. No. 11/620,673, filed Jan. 7, 2007 in the name of Darshan, entitled “Measurement of Cable Quality by Power Over Ethernet”, the entire contents of which is incorporated herein by reference, is addressed to method of determining impedance comprising: supplying power to a PD from a PSE at a first current limited level, denoted Iₗᵢₘ₁; measuring, at a plurality of times a voltage associated with the output of the PSE; determining a minimum voltage, Vₘᵢₙ₁, of the measured plurality of voltages; determining an associated time of the determined Vₘᵢₙ₁; removing the supplied power from the PD; subsequent to the removing, supplying power to the PD from the PSE at a second current limited level, denoted Iₗᵢₘ₂, Iₗᵢₘ₂ being different than the Iₗᵢₘ₁; measuring, at the determined associated time in relation to the beginning of the supplying power at Iₗᵢₘ₂, a voltage associated with the output of the power sourcing equipment, denoted Vₘᵢₙ₂; and determining an impedance responsive to Vₘᵢₙ₁, Vₘᵢₙ₂, Iₗᵢₘ₁ and Iₗᵢₘ₂. However, no provision is made in the above subject patent application for adjusting current levels and limits between the power sourcing equipment and the powered device responsive to the determined effective resistance.

U.S. Pat. No. 6,614,236 issued Sep. 2, 2005 to Karam, the entire contents of which is incorporated by reference, is addressed to a method and apparatus for measuring the length of a cable link in a computer network. Measurements of the signal transit time, decrease in signal amplitude, and decrease in signal power are three techniques that may be used to measure cable lengths, individually or in combination. The decrease in signal amplitude technique, in particular, assumes knowledge of the actual type of cable being measured, which unfortunately requires a difficult physical inspection.

U.S. Pat. No. 6,438,163 issued Aug. 20, 2002 to Raghavan et al, the entire contents of which is incorporated herein by reference, is addressed to a receiver that calculates the length of the transmission channel cable based on the receiver parameters. The cable length is calculated based on the gain of an automatic gain control or is based on multiplier coefficients of an equalizer of the receiver. The technique disclosed assumes knowledge of the actual type of cable being measured, which unfortunately requires a difficult physical inspection.

What is needed, and not provided by the prior art, is a method of determining a metric of the constituent wires connected the PD to the PSE, and providing power responsive to the determined metric.

### SUMMARY OF THE INVENTION

Accordingly, it is a principal object of the present invention to overcome the disadvantages of the prior art by providing power from a PSE to a PD over communication cabling with current limits set at the PSE responsive to the current carrying capability of the communication cabling. In particular, the length of cable between the power sourcing equipment and powered device is determined and the effective resistance between the PSE and the PD is further determined. A metric, such as the diameter, the effective resistance per unit length and/or the maximum safe current carrying capability of the constituent wires of the communication cabling connecting the PSE and the PD is calculated. Current limits are instituted, and power is delivered, from the PSE to the PD responsive to the calculated metric.

In one embodiment, the metric is used to determine a cable type installed, and the current limits are selected from a look up table. In another embodiment, the metric is used to calculate a maximum current, and the current levels are instituted responsive to the calculated maximum current.

In one embodiment, in the event that the determined effective resistance of the cable is less than a predetermined minimum, the determined length is less than a predetermined minimum, or a calculated metric of the constituent wire is less than a predetermined minimum, current limits in accordance with a respective standard specification are implemented.

The invention provides for a method of powering a powered device over communication cabling from a power sourcing equipment, the method comprising: determining the effective resistance between the power sourcing equipment and the powered device; determining the length of the communication cabling connecting the power sourcing equipment and the powered device; and calculating a metric of the constituent wires of the communication cabling between the power sourcing equipment and the powered device responsive to said determined effective resistance and said determined length.

Additional features and advantages of the invention will become apparent from the following drawings and description.

### BRIEF DESCRIPTION OF THE DRAWINGS

For a better understanding of the invention and to show how the same may be carried into effect, reference will now be made, purely by way of example, to the accompanying drawings in which like numerals designate corresponding sections or elements throughout.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawings:

FIG. 1A illustrates a high level block diagram of a first alternative network configuration for remote powering from an endpoint PSE in accordance with a principle of the current invention;

FIG. 1B illustrates a high level block diagram of a second alternative network configuration for remote powering from an endpoint PSE in accordance with a principle of the current invention;

FIG. 2 illustrates a timing diagram of current flow between the PSE and PD, in accordance with a principle of the invention, exhibiting two impressed disparate current flow levels prior to connecting power to PD operational circuitry;

FIG. 3 illustrates a high level flow chart of the operation of any of the systems of FIGS. 1A-1B to determine the effective resistance between the PSE and the PD according to a principle of the current invention;

FIG. 4 illustrates a high level flow chart of a first embodiment of the operation of the power sourcing equipment of any of the systems of FIGS. 1A-1B to power a PD responsive to a calculated metric of the constituent wires of the communication cabling in accordance with a principle of the current invention; and

FIG. 5 illustrates a high level flow chart of a second embodiment of the operation of the power sourcing equipment of any of the systems of FIGS. 1A-1B to power a PD responsive to a calculated metric of the constituent wires of the communication cabling in accordance with a principle of the current invention.

### DETAILED DESCRIPTION OF THE PREFERRED EMBODIMENTS

The present embodiments enable powering a PD over communication cabling with current limits at the PSE set responsive to the current carrying capability of the communication cabling. In particular, the length of cable between the power sourcing equipment and powered device is determined and the effective resistance between the PSE and the PD is further determined. A metric, such as the diameter, the effective resistance per unit length and/or the maximum safe current carrying capability of the constituent wires of the communication cabling connecting the PSE and the PD is calculated. Current limits are instituted, and power is delivered, from the PSE to the PD responsive to the calculated metric.

In one embodiment, the calculated metric is to determine a cable type installed, and the current limits are selected from a look up table. In another embodiment, the metric is used to calculate a maximum current, and the current levels are instituted responsive to the calculated maximum current.

In one embodiment, in the event that the determined effective resistance of the cable is less than a predetermined minimum, the determined length is less than a predetermined minimum, or the calculated metric of the constituent wire is less than a predetermined minimum, current limits in accordance with a respective standard specification are implemented.

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

The invention is being described as an Ethernet based network, with a powered device being connected thereto. It is to be understood that the powered device is preferably an IEEE 802.3 compliant device preferably employing a 10Base-T, 100Base-T or 1000Base-T connection.

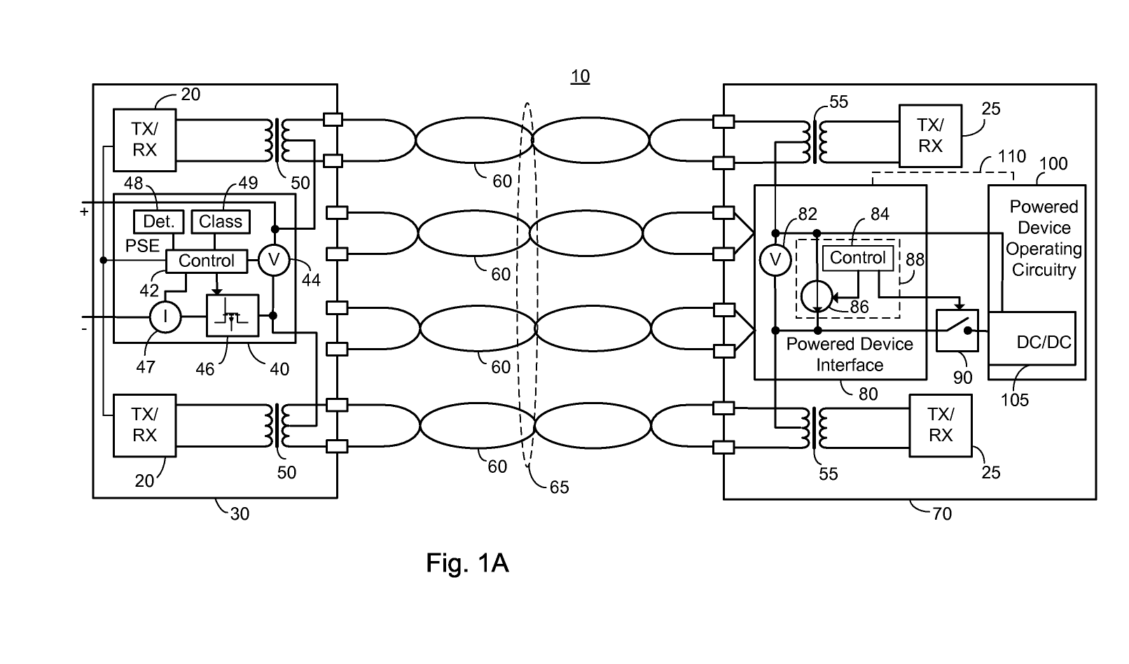

FIG. 1A illustrates a high level block diagram of a first alternative network configuration 10 for remote powering from an endpoint PSE in accordance with a principle of the current invention. Network configuration 10 comprises: a switch/hub equipment 30 comprising a first and a second transceiver 20, a PSE 40 and a first and a second data transformer 50; a first, a second, a third and a fourth twisted pair connection 60 constituting a communication cabling 65; and a powered end station 70 comprising a PD interface 80, a first and a second data transformer 55, a first and a second transceiver 25, an isolating switch 90, and a PD operating circuitry 100 comprising a DC/DC converter 105. PSE 40 comprises a control circuitry 42, a voltage measuring means 44, an electronically controlled current limiter and switch 46, a current measuring means 47, a detection functionality 48 and a classification functionality 49. PD interface 80 comprises a voltage measuring means 82, a PD interface control circuitry 84 and a current level impresser 86 illustrated as a variable current source. Optionally, PD interface control circuitry 84 and current level impresser 86 constitute a transmitter 88. Powered end station 70 is alternatively denoted PD 70.

A positive power source lead is connected to a first input of voltage measuring means 44 and the center tap of the secondary of first data transformer 50. A negative power source lead is connected to a first end of current measuring means 47, and a second end of current measuring means 47 is connected to a first port of electronically controlled current limiter and switch 46. A second port of electronically controlled current limiter and switch 46 is connected to a return input of voltage measuring means 44 and the center tap of the secondary of second data transformer 50. An output of control circuitry 42 is connected to the control port of electronically controlled current limiter and switch 46, the output of current measuring means 47 is connected to an input of control circuitry 42 and the output of voltage measuring means 44 is connected to an input of control circuitry 42. Each of detection functionality 48 and classification functionality 49 are in communication with control circuitry 42. The primary of first and second data transformers 50 are each connected to a respective transceiver 20. Each transceiver 20 is in communication with control circuitry 42, and control circuitry 42 is operative in cooperation with transceivers 42 to provide cable length determining functionality, preferably in accordance with the teaching of U.S. Pat. No. 6,614,236 issued Sep. 2, 2005 to Karam incorporated above.

The output leads of the secondary of first and second data transformers 50 are each connected to a first end of first and second twisted pair connections 60, respectively. The second end of first and second twisted pair connections 60 are respectively connected to the primary of first and second data transformers 55 located within PD 70. The center tap of the primary of first data transformer 55 is connected, as the power input of PD interface 80, to a first end of voltage measuring means 82, a first end of current level impresser 86 and to the power input of PD operating circuitry 100 at DC/DC converter 105. The center tap of the primary of second data transformer 55 is connected, as the power return of PD interface 80, to a second end of voltage measuring means 82, a second end of current level impresser 86 and a first port of isolating switch 90. The control port of isolating switch 90 is connected to an output of PD interface control circuitry 84, and a second port of isolating switch 90 is connected to the power return of PD operating circuitry 100 at DC/DC converter 105. An optional data path 110 is provided between PD interface 80 and PD operating circuitry 100.

In a preferred embodiment first and second data transformers 55 are part of PD interface 80. Preferably PD interface 80 comprises a diode bridge (not shown) arranged to ensure proper operation of PD 70 irrespective of the polarity of the connection to PSE 40. The secondary of first and second data transformers 55 are respectively connected to transceivers 25.

In operation, control circuitry 42 of PSE 40 detects PD 70 via detection functionality 48, optionally classifies PD 70 via classification functionality 49, and if power is available, supplies power over first and second twisted pair connection 60 to PD 70, by setting current limit values of electronically controlled current limiter and switch 46 in accordance with applicable standards, and closing electronically controlled current limiter and switch 46, thus supplying both power and data over first and second twisted pair connections 60 of communication cabling 65. Third and fourth twisted pair connections 60 are not utilized, and are thus available as spare connections. Third and fourth twisted pair connections 60 are shown connected to PD interface 80 in order to allow operation alternatively in a manner that will be described further hereinto below in relation to FIG. 1B over unused third and fourth twisted pair connections 60.

PD interface 80 functions to present a signature resistance (not shown) to PSE 40 thus enabling detection by detection functionality 48, optionally present a classification current in cooperation with classification functionality 49, and upon detection, via voltage measuring means 82, of a voltage indicative of remote powering from PSE 40, impress at least two disparate current flow levels, denoted I₁, I₂, between PSE 40 and PD 70 via current level impresser 86. In particular PD interface circuitry 84 operates current level impresser 86 to source disparate current levels thereby determining the current flow between PSE 40 and PD 70. Isolating switch 90 is not closed so as to prevent startup of DC/DC converter 105, and its associated current fluctuations. Current flow levels I₁, I₂ are termed disparate in that they are sufficiently different so as to generate measurably different voltages at PD interface 80, to be measured by voltage measuring means 82, and at PSE 40, to be measured by voltage measuring means 44. In one embodiment each of voltage measuring means 44 and 82 comprises an A/D converter and thus the current flow levels must be sufficiently different to create discernibly different readings. In one embodiment I₁ and I₂ are separated by about 10 mA.

PD interface 80 further measures the voltage at PD interface 80, via voltage measuring means 82, responsive to each of current flow levels I₁, I₂, denoted respectively V_{PD1}, V_{PD2}, and transmits measurement readings V_{PD1}, V_{PD2}. In one embodiment measurement readings V_{PD1}, V_{PD2} are transmitted to control circuitry 42, and in another embodiment the measurement readings V_{PD1}, V_{PD2} are transmitted to one of a host (not shown) and a master control (not shown), as described further hereinto below. In one embodiment measurement readings V_{PD1}, V_{PD2} are transmitted by optional transmitter 88, by impressing a plurality of current levels utilizing current impresser 86 as described in U.S. Pat. No. 7,145,439 issued Dec. 5, 2006 to Darshan et al, the entire contents of which is incorporated herein by reference. In yet another embodiment, the measurement readings V_{PD1}, V_{PD2} are sent via optional data path 110 to PD operating circuitry 100, and transmitted over the data network by PD operating circuitry 100, typically as a layer 2 transaction, and is received by control circuitry 42 from a host (not shown).

Control circuitry 42 of PSE 40 measures the voltage at PSE 40, preferably at the output port thereof, via voltage measuring means 44, responsive to each of current flow levels I₁, I₂, denoted respectively V_{PSE1}, V_{PSE2}. Optionally, control circuitry 42 of PSE 40 further measures the current flow levels I₁, I₂ via current measuring means 47. The effective resistance between PSE 40 and PD 70 is then determined as a function of V_{PSE1}, V_{PSE2}, V_{PD1}, V_{PD2} and I₁, I₂. In one embodiment I₁, I₂ are predetermined values and in another embodiment, as described above, I₁, I₂ are measured values. In particular, preferably the effective resistance, denoted R_{eff}, is calculated as:

R_{eff}=((V_{PSE1}−V_{PSE2})−(V_{PD1}−V_{PD2}))/(I₁−I₂) Eq. 1

The above has been described in an embodiment in which the effective resistance is calculated at PSE 40, however this is not meant to be limiting in any way. In another embodiment the effective resistance is calculated by a master controller (not shown), as will be described further hereinto below, or at a host (not shown) wherein all measurements are sent. In yet another embodiment R_{eff} is calculated by PD operating circuitry 100, and the measurements of PSE 40 are sent to PD operating circuitry 100 over the data network. In yet another embodiment R_{eff} is calculated in accordance with the teaching of U.S. patent application Ser. No. 11/620,673 in the name of Darshan, incorporated above.

In the event that R_{eff} determined above is outside of a predetermined range, a fault condition may be flagged to a host for service personnel action. The above has been described in an embodiment in which two disparate current levels are impressed, however this is not meant to be limiting in any way. Three or more current levels may be utilized without exceeding the scope of the invention. After PD interface control circuitry 84 has completed impressing current levels I₁, I₂, and optionally transmitting V_{PD1}, V_{PD2} by impressing current levels, PD interface control circuitry 84 closes isolating switch 90 thereby powering PD operating circuitry 100 with initial current limits associated with the appropriate standard, including without limitation, IEEE 802.3af or the developing IEEE 802.3at standard.

As indicated above, transceivers 20, in cooperation with control circuitry 42, are preferably operative to determined the length of twisted pair connections 60 constituting a communication cabling between PSE 40 and PD 70, and communicate said length determination to control circuitry 42. Control circuitry 42, responsive to the communicated length determination, and the calculated effective resistance as described above, is operative to calculate a metric of the constituent wires of communication cabling 65 connecting PSE 40 and PD 70. In the event that the determined length of communication cabling 65 connecting PSE 40 and PD 70 is not greater than a predetermined amount, the calculated effective resistance is not greater than a predetermined minimum amount, or the calculated metric of the constituent wires of communication cabling 65 is indicative that the constituent wires are not capable of increased current handling as compared with those associated with the current limit of the respective appropriate standard, powering is continued with the initial current limits associated with the appropriate standard. In one particular embodiment the calculated metric is a cross-sectional metric, and the cross-sectional metric is compared with a cross section of the minimum cabling associated with the current limit of the respective appropriate standard.

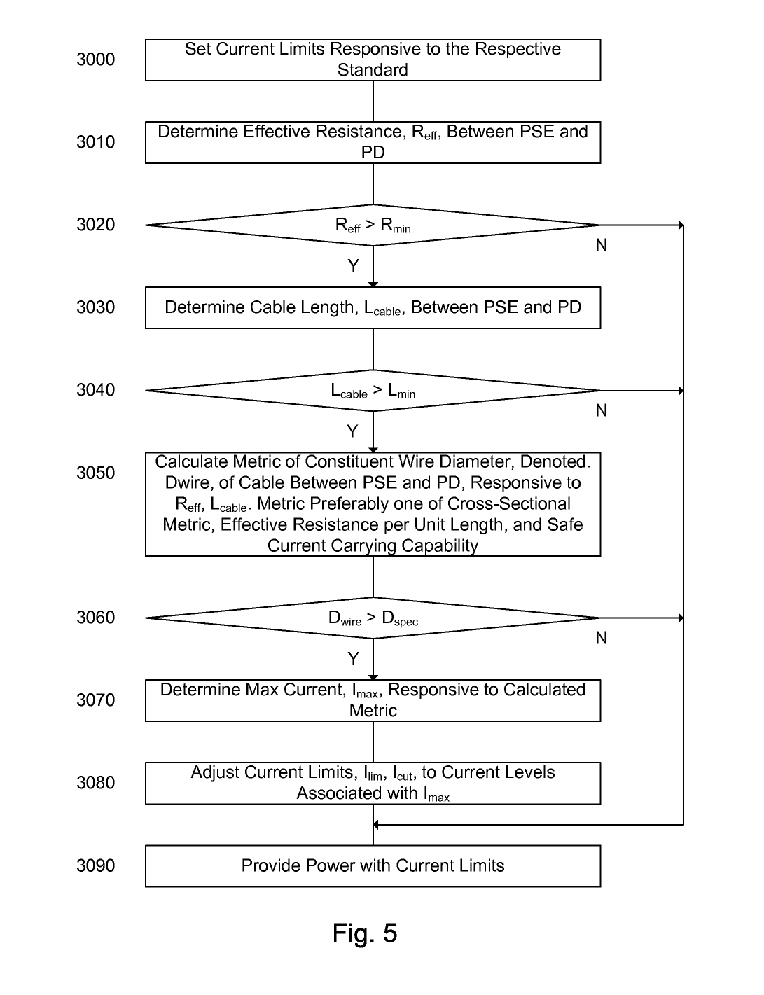

In the event that the determined length of communication cabling 65 connecting PSE 40 and PD 70 is greater than a predetermined amount, the calculated effective resistance is greater than a predetermined minimum amount and the calculated metric of the constituent wires is indicative that the constituent wires are capable of increased current handling without excessive temperature rise as compared with the current limit of the respective appropriate standard, powering is continued responsive to the calculated metric. Preferably, the current limits applied to electronically controlled current limiter and switch 46 are adjusted, as will be described further hereinto below in relation to FIGS. 5A, 5B, to increase the allowable current limits responsive to the calculated metric.

FIG. 1A has been illustrated in an embodiment in which power is transmitted on only 2 pairs of conductors of communication cabling 65, however this is not meant to be limiting in any way. In another embodiment power is transmitted on all conductors of communication cabling 65 without exceeding the scope of the invention.

FIG. 1B illustrates a high level block diagram of a second alternative network configuration 150 for remote powering from an endpoint PSE in accordance with a principle of the current invention. Network configuration 150 comprises: a switch/hub equipment 30 comprising a first and a second transceiver 20, a PSE 40 and a first and a second data transformer 50; a first, a second, a third and a fourth twisted pair connection 60 constituting a communication cabling 65; and a PD 70 comprising a PD interface 80, a first and a second data transformer 55, a first and a second transceiver 25, an isolating switch 90, and a PD operating circuitry 100 comprising a DC/DC converter 105. PSE 40 comprises a control circuitry 42, a voltage measuring means 44, an electronically controlled current limiter and switch 46, a current measuring means 47, a detection functionality 48 and a classification functionality 49. PD interface 80 comprises a voltage measuring means 82, a PD interface control circuitry 84 and a current level impresser 86 illustrated as a variable current source. Optionally, PD interface control circuitry 84 and current level impresser 86 constitute a transmitter 88. Powered end station 70 is alternatively denoted PD 70.

A positive power source lead is connected to a first input of voltage measuring means 44 and to both leads of a first end of third twisted pair connection 60. A negative power source lead is connected to a first end of current measuring means 47, and a second end of current measuring means 47 is connected to a first port of electronically controlled current limiter and switch 46. A second port of electronically controlled current limiter and switch 46 is connected to a return input of voltage measuring means 44 and to both leads of a first end of fourth twisted pair connection 60. An output of control circuitry 42 is connected to the control port of electronically controlled current limiter and switch 46, the output of current measuring means 47 is connected to an input of control circuitry 42 and the output of voltage measuring means 44 is connected to an input of control circuitry 42. Each of detection functionality 48 and classification functionality 49 are in communication with control circuitry 42. The primary of first and second data transformers 50 are connected to a respective transceiver 20, respectively. Each transceiver 20 is in communication with control circuitry 42, and is operative in cooperation with control circuitry 42 to provide cable length determining functionality, preferably in accordance with the teaching of U.S. Pat. No. 6,614,236 issued Sep. 2, 2005 to Karam incorporated above.

The output leads of the secondary of first and second data transformers 50 are each connected to a first end of first and second twisted pair connections 60, respectively. The second end of first and second twisted pair connection 60 is connected to the primary of first and second data transformer 55, respectively, located within PD 70. The center tap of the primary of first and second data transformer 55 is connected to PD interface 80. The second end of both leads of third twisted pair connection 60 is connected, as the power input of PD interface 80, to a first end of voltage measuring means 82, a first end of current level impresser 86 and to the power input of PD operating circuitry 100 at DC/DC converter 105. The second end of both leads of fourth twisted pair connection 60 is connected, as the power return of PD interface 80, to a second end of voltage measuring means 82, a second end of current level impresser 86 and a first port of isolating switch 90. The control port of isolating switch 90 is connected to an output of PD interface control circuitry 84, and a second port of isolating switch 90 is connected to the power return of PD operating circuitry 100 at DC/DC converter 105. An optional data path 110 is provided between PD interface 80 and PD operating circuitry 100.

In a preferred embodiment, first and second data transformers 55 are part of PD interface 80. Preferably, PD interface 80 comprises a diode bridge 85 (not shown) arrange to ensure proper operation of PD 70 irrespective of the polarity of the connection to PSE 40. The secondary of first and second data transformers 55 are respectively connected to transceivers 25.

In operation, control circuitry 42 of PSE 40 detects PD 70 via detection functionality 48, optionally classifies PD 70 via classification functionality 49, and if power is available, supplies power over third and fourth twisted pair connections 60 to PD 70, by setting current limit values of electronically controlled current limiter and switch 46 in accordance with applicable standards, and closing electronically controlled current limiter and switch 46, thus supplying over first and second twisted pair connections 60. Power and data are thus supplied over separate connections, and are not supplied over a single twisted pair connection. The center tap connection of first and second data transformer 55 is not utilized, but is shown connected in order to allow operation alternatively as described above in relation to network configuration 10 of FIG. 1A. Network configurations 10 and 150 thus allow for powering PD 70 by PSE 40 either over the set of twisted pair connections 60 utilized for data communications, or over the set of twisted pair connections 60 not utilized for data communications.

PD interface 80 functions to present a signature resistance (not shown) to PSE 40 for detection by detection functionality 48, optionally present a classification current in cooperation with classification functionality 49, and upon detection of a voltage, via voltage measuring means 82, indicative of remote powering from PSE 40, impresses at least two disparate current flow levels, denoted I₁, I₂, between PSE 40 and PD 70 via current level impresser 86. In particular, PD interface circuitry 84 operates current level impresser 86 to source disparate current levels thereby determining the current flow between PSE 40 and PD 70. Isolating switch 90 is not closed so as to prevent startup of DC/DC converter 105, and its associated current fluctuations. Current flow levels I₁, I₂ are termed disparate in that they are sufficiently different so as to generate measurably different voltages at PD interface 80, to be measured by voltage measuring means 82, and at PSE 40, to be measured by voltage measuring means 44. In one embodiment each of voltage measuring means 44 and 82 comprises an A/D converter and thus the current flow levels must be sufficiently different to create discernibly different readings. In one embodiment I₁ and I₂ are separated by about 10 mA.

PD interface 80 further measures the voltage at PD interface 80, via voltage measuring means 82, responsive to each of current flow levels I₁, I₂, denoted respectively V_{PD1}, V_{PD2}, and transmits measurement readings V_{PD1}, V_{PD2}. In one embodiment the measurement readings V_{PD1}, V_{PD2} are transmitted to control circuitry 42, and in another embodiment measurement readings V_{PD1}, V_{PD2} are transmitted to one of a host (not shown) and a master control, as described further hereinto below. In one embodiment measurement readings V_{PD1}, V_{PD2} are transmitted by optional transmitter 88, by impressing a plurality of current levels as described in the above referenced U.S. Pat. No. 7,145,439 issued Dec. 5, 2006 to Darshan et al. In yet another embodiment, measurement readings V_{PD1}, V_{PD2} are sent via optional data path 110 to PD operating circuitry 100, and transmitted over the data network by PD operating circuitry 100, typically as a layer 2 transaction and is received by control circuitry 42 from a host (not shown).

Control circuitry 42 of PSE 40 measures the voltage at PSE 40, preferably at the output port thereof, via voltage measuring means 44, responsive to each of current flow levels I₁, I₂, denoted respectively V_{PSE1}, V_{PSE2}. Optionally, control circuitry 42 of PSE 40 further measures the current flow levels I₁, I₂ via current measuring means 47. The effective resistance between PSE 40 and PD 70, denoted R_{eff}, is then determined as a function of V_{PSE1}, V_{PSE2}, V_{PD1}, V_{PD2} and I₁, I₂. In one embodiment I₁, I₂ are predetermined values and in another embodiment, as described above, I₁, I₂ are measured values. Preferably, R_{eff} is calculated as described in Eq. 1, above.

The above has been described in an embodiment in which the effective resistance is calculated at PSE 40, however this is not meant to be limiting in any way. In another embodiment the effective resistance is calculated by a master controller (not shown), as will be described further hereinto below, or at a host (not shown) wherein all measurements are sent. In yet another embodiment the effective resistance is calculated by PD operating circuitry 100, and the measurements of PSE 40 are sent to PD operating circuitry 100 over the data network. In yet another embodiment R_{eff} is calculated in accordance with the teaching of U.S. patent application Ser. No. 11/620,673 in the name of Darshan, incorporated above.

In the event that R_{eff} determined above is outside of a predetermined range, a fault condition may be flagged to a host for service personnel action. The above has been described in an embodiment in which two disparate current levels are impressed, however this is not meant to be limiting in any way. Three or more current levels may be utilized without exceeding the scope of the invention. After PD interface control circuitry 84 has completed impressing I₁, I₂, and optionally transmitting V_{PD1}, V_{PD2} by impressing current levels, PD interface control circuitry 84 closes isolating switch 90 thereby powering PD operating circuitry 100 with initial current limits associated with the appropriate standard, including without limitation, IEEE 802.3af or the developing IEEE 802.3at standard.

As indicated above, transceivers 20 in cooperation with control circuitry 42 are preferably operative to determined the length of twisted pair connections 60 constituting a communication cabling between PSE 40 and PD 70, and communicate said length determination to control circuitry 42. Control circuitry 42, responsive to the communicated length determination, and the calculated effective resistance as described above, is operative to calculate a metric of the constituent wires of communication cabling 65 connecting PSE 40 and PD 70. In the event that the determined length of communication cabling 65 connecting PSE 40 and PD 70 is not greater than a predetermined amount, the calculated effective resistance is not greater than a predetermined minimum amount, or the calculated metric of the constituent wires of communication cabling 65 is indicative that the constituent wires are not of greater cross section than those associated with the current limit of the respective appropriate standard, powering is continued with the initial current limits associated with the appropriate standard. In one particular embodiment the calculated metric is a cross-sectional metric, and the cross-sectional metric is compared with a cross section of the minimum cabling associated with the current limit of the respective appropriate standard.

In the event that the determined length of communication cabling 65 connecting PSE 40 and PD 70 is greater than a predetermined amount, the calculated effective resistance is greater than a predetermined minimum amount and the calculated metric of the constituent wires is indicative that the constituent wires are capable of increased current handling without excessive temperature rise as compared with the current limit of the respective appropriate standard, powering is continued responsive to the calculated metric. Preferably, the current limits applied to electronically controlled current limiter and switch 46 are adjusted, as will be described further hereinto below in relation to FIGS. 5A, 5B, to increase the allowable current limits responsive to the calculated metric.

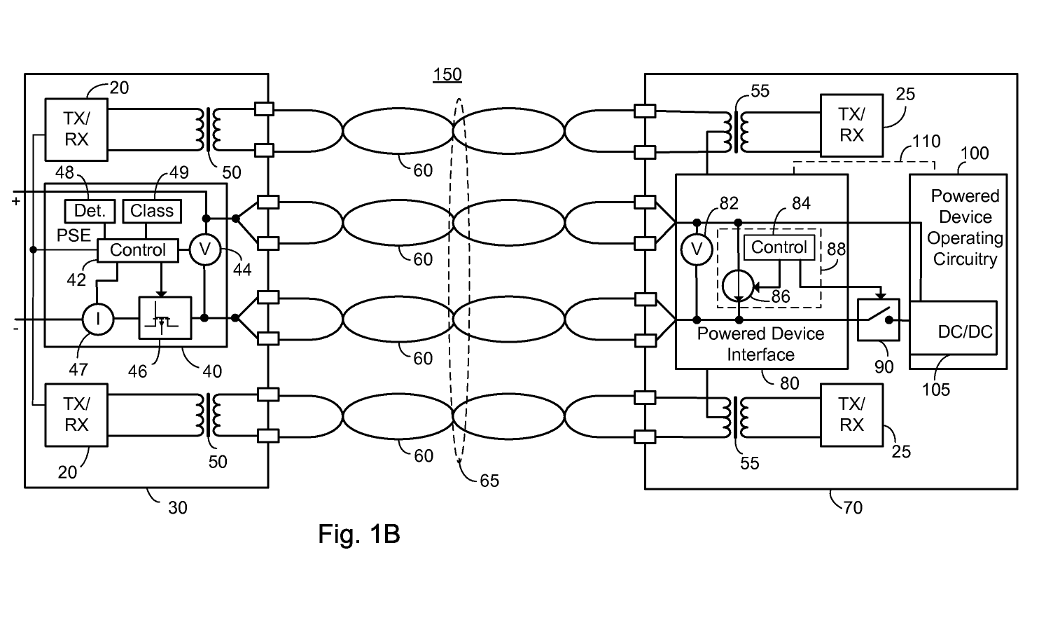

FIG. 2 illustrates a timing diagram of current flow between PSE 40 and PD 70 of any of FIGS. 1A-1B, in accordance with a principle of the invention, to impress two disparate current levels prior to connecting power to PD operational circuitry. The x-axis represents time and the y-axis represents current flow between PSE 40 and PD 70 in arbitrary units. Classification current waveform 200, representing a classification current value, denoted I_{class}, is presented responsive to a particular voltage output of classification functionality 49.

Responsive to a sensed operating voltage supplied from PSE 40, current waveform 210 exhibits a rising leading slope 220 as current begins to flow between PSE 40 and PD interface 80. In prior art systems, isolating switch 90 would be closed responsive to the sensed operating voltage thereby delivering power to DC/DC converter 105. In accordance with a principle of the subject invention, isolating switch 90 is not closed, but instead a first current flow level 230 and a second current flow level 240 are impressed upon the current flow between PSE 40 and PD interface 80. In one embodiment the two current flow levels represent multi-bit communication as described in the above referenced U.S. Pat. No. 7,145,439 issued Dec. 5, 2006 to Darshan et al.

After completion of any communication between PD interface 80 and PSE 40, or in the event that no communication occurs after impressing first current level 230 and second current level 240, isolating switch 90 is closed thereby supplying power to PD operating circuitry 100 and enabling the start up of DC/DC converter 105. Waveform 250 represents the operating condition of DC/DC converter 105 exhibiting a nominal value with momentary fluctuations. First and second current levels 230, 240 are preferably each impressed for a predetermined time period, thereby enabling acquisition by control circuitry 42. Preferably, first and second current levels 230, 240 are impressed repeatedly to ensure accurate measurement.

Preferably, first current flow level 230 and second current flow level 240 are disparate current levels being sufficiently different so as to enable determination of the effective resistance between PSE 40 and PD interface 80. In particular, in one embodiment first current flow level 230 represents approximately 10 mA and second current flow level 240 represents approximately 20 mA.

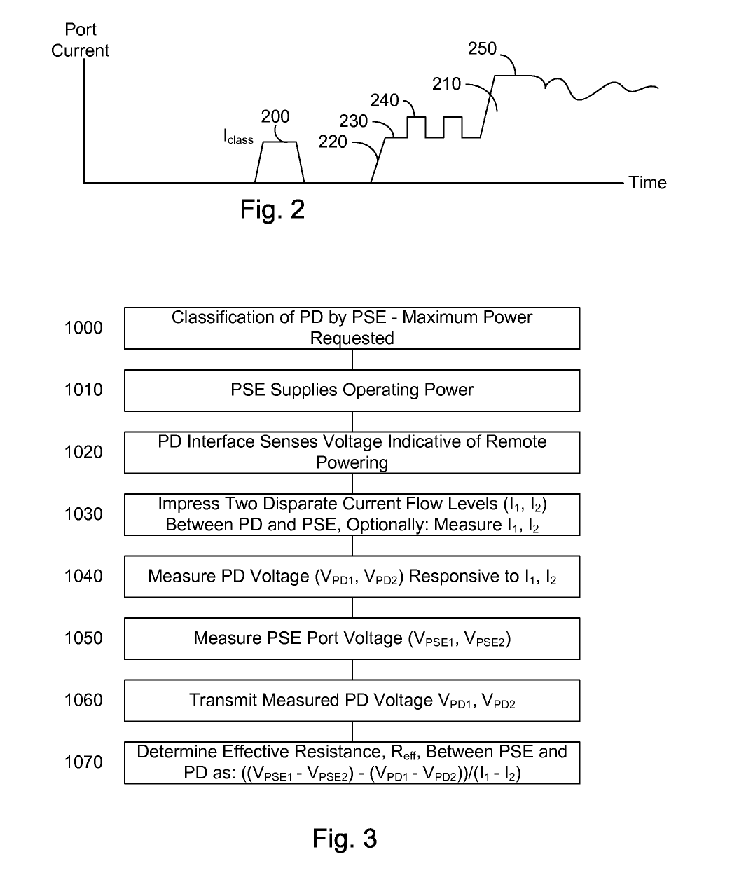

FIG. 3 illustrates a high level flow chart of the operation of any of systems 10, 150 of FIGS. 1A-1B to determine the effective resistance between PSE 40 and PD 70 according to a principle of the current invention. In stage 1000, PSE 40 classifies PD 70 via classification functionality 49. Classification of PD 70, in accordance with IEEE 802.3 af, determines the maximum requested power of PD 70. It is to be understood by those skilled in the art that prior to classification of stage 1000, detection of PD 70 is performed via detection functionality 48.

In stage 1010, PSE 40 supplies operating power, if available, to PD interface 80 over communication cabling 65 by setting appropriate current limits and closing electronically controlled current limiter and switch 46. In stage 1020, control circuitry 84 of PD interface 80 senses voltage indicative of remote powering from PSE 40 via voltage measuring means 82. In stage 1030, control circuitry 84 impresses two disparate current flow levels, denoted I₁, I₂, between PD interface 80 and PSE 40. Optionally, control circuitry 42 of PSE 40 measures the actual current flow levels between PD interface 80 and PSE 40 via current measuring means 47.

In stage 1040, control circuitry 84 of PD interface 80 measures the PD voltage, denoted V_{PD1}, V_{PD2}, respectively, responsive to the two disparate current flow levels I₁, I₂. V_{PD1}, V_{PD2} are measured via voltage measuring means 82. In stage 1050, the port voltage of PSE 40, responsive to the two disparate current flow levels I₁, I₂, and denoted V_{PSE1}, V_{PSE2}, respectively, are measured via voltage measuring means 44 of PSE 40. Preferably, control circuitry 42 detects disparate current flow levels I₁, I₂, within a predetermined time period from the operation of stage 1010, and responsive to the detected disparate current flow levels I₁, I₂, measures the voltage via voltage measuring means 44. In stage 1060, measured voltages V_{PD1}, V_{PD2} of stage 1040 are transmitted from PD 70 to PSE 40. In one embodiment measured voltages V_{PD1}, V_{PD2} are transmitted via PD to PSE communication as described in the above referenced U.S. Pat. No. 7,145,439 issued Dec. 5, 2006 to Darshan et al. In another embodiment measured voltages V_{PD1}, V_{PD2} are communicated via optional data path 110 to PD operating circuitry 100. PD operating circuitry 100 transmits measured voltages V_{PD1}, V_{PD2} via a level 2 transaction to one of control circuitry 42, a host (not shown) and a master controller (not shown) as will be described further hereinto below in relation to FIG. 5.

In stage 1070, effective resistance, denoted R_{eff}, is determined as a function of V_{PSE1}, V_{PSE2} of stage 1050; V_{PD1}, V_{PD2} of stage 1040; and I₁, I₂ of stage 1030. Preferably, I₁, I₂ are measured values as described above in relation to stage 1030. In another embodiment, I₁, I₂ are nominal values as set in the manufacture of current impresser 86 of FIGS. 1A-1B. Preferably, R_{eff} is determined as described above in relation to the Eq. 1.

Thus, the method of FIG. 3 enables determination of the effective resistance between PSE 40 and PD 70 responsive to the impressing of two disparate current flow levels between PSE 40 and PD 70 and in particular between PSE 40 and PD interface 80. Thus, control circuitry 42 in cooperation with control circuitry 84 and voltage measuring means 44, 82 represent an embodiment of an effective resistance determining functionality.

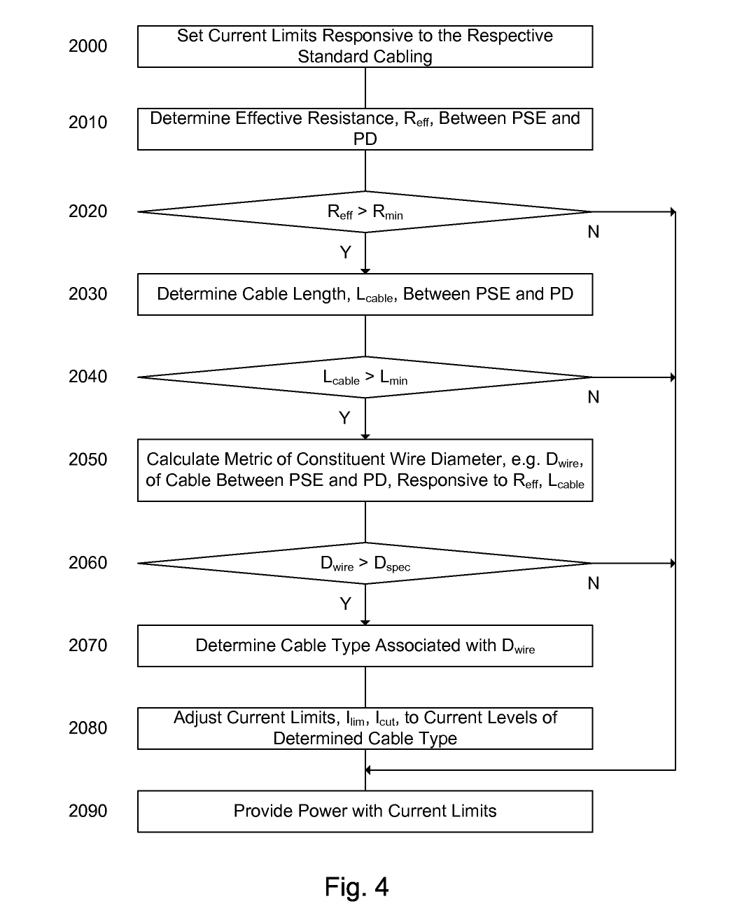

FIG. 4 illustrates a high level flow chart of a first embodiment of the operation of PSE 40 of any of systems 10, 150 of FIGS. 1A-1B to power a PD responsive to a calculated metric of the constituent wires of communication cabling 65. In stage 2000, initial current limits for electronically controlled current limiter and switch 46 are set in accordance with the appropriate respective standard, such as without limitation one of IEEE 802.3af and the developing IEEE 802.3at standard which are based on the safe current carrying capabilities of a particular minimum cabling. In the event power is required to be delivered from PSE 40 to PD 70 in order to determine the cable length and/or the effective resistance between PSE 40 and PD 70, power is provided in accordance with the initial current limits of stage 2000.

In stage 2010, the effective resistance between PSE 40 and PD 70, denoted R_{eff}, is determined, as described above in relation to FIGS. 2, 3 and Eq. 1. Control circuitry 42, in cooperation with control circuitry 84 and voltage measuring means 44, 82 provides the functionality to determine R_{eff}, thus comprises an effective resistance determining functionality. In stage 2020, R_{eff} of stage 2010 is compared with a minimum resistance, denoted Rₘᵢₙ, selected to ensure that for extremely low determined resistance, for which the determination of the constituent wire metric is unreliable, and to prevent current imbalance, the initial current limits of stage 2000 are retained. In the event that R_{eff} is greater than Rₘᵢₙ, in stage 2030 the cable length, denoted L_{cable}, of the communication cabling connecting PSE 40 and PD 70 is determined. In one embodiment, L_{cable} is determined in accordance with the teachings of U.S. Pat. No. 6,614,236 to Karam, incorporated above. In stage 2040, L_{cable} of stage 2030 is compared with a minimum cable length, denoted Lₘᵢₙ, selected to ensure that for short cable lengths, for which the determination of the constituent wire metric is unreliable, and to prevent current imbalance, the initial current limits of stage 2000 are retained.

In the event that L_{cable} is greater than Lₘᵢₙ, in stage 2050 the metric of the constituent wires of the communication cabling, such as the diameter denoted D_{wire}, of the communication cabling connecting PSE 40 and PD 70 is determined. The metric may comprise the diameter, radius or other cross sectional area, the effective resistance per unit length, or safe current carrying capability of the constituent wires of communication cabling 65 without exceeding the scope of the invention. In one embodiment, the metric is a cross-sectional metric and is determined in accordance with the equation:

R_{eff}=ρ*L_{cable}/A Eq. 2

where ρ denotes the constituent wire resistivity, typically expressed in ohms-m, and A denotes the cross sectional area of the constituent wires in m².

In stage 2060, the metric, such as D_{wire} of stage 2050, is compared with a minimum metric, denoted D_{spec}, thus ensuring that current limits are only adjusted for constituent wires exhibiting a metric indicative of an increased current handling than the metric of cabling associated with the appropriate standard of stage 2000.

In the event that D_{wire} is greater than D_{spec}, in stage 2070 the metric of stage 2050 is utilized to determine the cable type associated with D_{wire}. It is to be understood that the determination of L_{cable} of stage 2030 and R_{eff} of stage 2010 are not precise, and thus the metric is rounded down to determine the cable type associated with D_{wire}.

In stage 2080, current limits such as Iₗᵢₘ and I_{cut}, associated with the determined cable type of stage 2070, preferably stored in a look up table in control circuitry 42, are used to modify the current limits of stage 2000 set in electronically controlled current limiter and switch 46. The current limits are selected such that communication cabling 65 will not exhibit a temperature rise in excess of a predetermined safety limit. It is to be understood that the term safe current carrying capability refers to the current which will result in the maximum temperature rise observing the predetermined safety limit. In stage 2090, power is continued to be supplied to PD 70, however with the current limits as modified in stage 2080.

In the event that in stage 2020, R_{eff} is not greater than Rₘᵢₙ, stage 2090 is performed, thus maintaining the supply of power with the current limits of stage 2000. In the event that in stage 2040, L_{cable} is not greater than Lₘᵢₙ, stage 2090 is performed, thus maintaining the supply of power with the current limits of stage 2000. In the event that in stage 2060, D_{wire} is not greater than D_{spec}, stage 2090 is performed, thus maintaining the supply of power with the current limits of stage 2000.

Thus, the method of FIG. 4 powers a PD 70 responsive to a calculated metric of the constituent wires of communication cabling 65.

FIG. 5 illustrates a high level flow chart of a second embodiment of the operation of PSE 40 of any of systems 10, 150 of FIGS. 1A-1B to power a PD responsive to a calculated metric of the constituent wires of communication cabling 65 in accordance with a principle of the current invention. In stage 3000, initial current limits for electronically controlled current limiter and switch 46 are set in accordance with the appropriate respective standard, such as without limitation one of IEEE 802.3af and the developing IEEE 802.3at standard, which are each based on a particular minimum cabling type. In the event power is required to be delivered from PSE 40 to PD 70 in order to determine the cable length and/or the effective resistance between PSE 40 and PD 70, power is provided in accordance with the initial current limits of stage 3000.

In stage 3010, the effective resistance between PSE 40 and PD 70, denoted R_{eff}, is determined, as described above in relation to FIGS. 2, 3 and Eq. 1. Control circuitry 42, in cooperation with control circuitry 84 and voltage measuring means 44, 82 provides the functionality to determine R_{eff}, thus comprises an effective resistance determining functionality. In stage 3020, R_{eff} of stage 3010 is compared with a minimum resistance, denoted Rₘᵢₙ, selected to ensure that for extremely low calculated resistance, for which the determination of the constituent wire metric is unreliable, and to prevent current imbalance, the initial current limits of stage 3000 are retained. In the event that R_{eff} is greater than Rₘᵢₙ, in stage 3030 the cable length, denoted L_{cable}, of the communication cabling connecting PSE 40 and PD 70 is determined. In one embodiment, L_{cable} is determined in accordance with the teachings of U.S. Pat. No. 6,614,236 to Karam, incorporated above. In stage 3040, L_{cable} of stage 3030 is compared with a minimum cable length, denoted Lₘᵢₙ, selected to ensure that for short cable lengths, for which the determination of the constituent wire metric is unreliable, and to prevent current imbalance, the initial current limits of stage 3000 are retained.

In the event that L_{cable} is greater than Lₘᵢₙ, in stage 3050 the metric of the constituent wires of the communication cabling, such as the diameter denoted D_{wire}, of the communication cabling connecting PSE 40 and PD 70 is determined. The metric may comprise the diameter, radius or other cross sectional area, the effective resistance per unit length, or the maximum safe current carrying capability of the constituent wires without exceeding the scope of the invention. In one embodiment, the metric is a cross-sectional metric determined in accordance with Eq. 2 described above.

In stage 3060, D_{wire} of stage 3050 is compared with a minimum metric, denoted D_{spec}, thus ensuring that current limits are only adjusted for constituent wires exhibiting a metric associated with a greater current carrying capability than the metric of cabling associated with the appropriate selected standard of stage 3000.

In the event that D_{wire} is greater than D_{spec}, in stage 3070 the maximum allowed current, denoted Iₘₐₓ, is determined such that the communication cabling will not exhibit a temperature rise in excess of a predetermined safety limit. In one embodiment, Iₘₐₓ is determined in accordance with:

Iₘₐₓ=2*I_{wire} Eq. 3

since current is carried in a pair of wires, and

$${I}_{wire} = \frac{D}{2} \sqrt{\frac{{T}_{r max} π}{{ϕ}_{cable} ρ {L}_{cable}}} \qquad Eq . 4$$

Where Tᵣₘₐₓ represents the maximum allowable temperature rise; L_{cable} represents the cable length of stage 3030; φ_{cable} represents the thermal resistance of the constituent wires, typically expressed in ° C./watt; and ρ denotes the constituent wire resistivity, typically expressed in ohms-m.

In stage 3080, current limits such as Iₗᵢₘ and I_{cut}, are developed responsive to, and associated with, Iₘₐₓ of Eq. 3, and are used to modify the current limits of stage 3000 set in electronically controlled current limiter and switch 46. In one embodiment, the current limits are derated by a safety factor. In stage 3090, power is continued to be supplied to PD 70, however with the current limits as modified in stage 3080.

In the event that in stage 3020, R_{eff} is not greater than Rₘᵢₙ, stage 3090 is performed, thus maintaining the supply of power with the current limits of stage 3000. In the event that in stage 3040, L_{cable} is not greater than Lₘᵢₙ, stage 3090 is performed, thus maintaining the supply of power with the current limits of stage 3000. In the event that in stage 3060, D_{wire} is not greater than D_{spec}, stage 3090 is performed, thus maintaining the supply of power with the current limits of stage 3000.

Thus, the method of FIG. 5 powers a PD 70 responsive to a calculated metric of the constituent wires of communication cabling 65.

Thus the present embodiments enable powering a PD over communication cabling with current limits at the PSE set responsive to the current carrying capability of the communication cabling. In particular, the length of cable between the power sourcing equipment and powered device is determined and the effective resistance between the PSE and the PD is further determined. A metric, such as the diameter, the effective resistance per unit length and/or the maximum safe current carrying capability, of the constituent wires of the communication cabling connecting the PSE and the PD is calculated. Current limits are instituted, and power is delivered, from the PSE to the PD responsive to the calculated diameter of the constituent wire, and/or the resultant maximum current.

In one embodiment, the metric is used to determine a cable type, and the current limits are selected from a look up table. In another embodiment, the calculated metric is used to calculate a maximum current, and the current levels are instituted responsive to the calculated maximum current.

In one embodiment, in the event that the determined effective resistance of the cable is less than a predetermined minimum, the determined length is less than a predetermined minimum, or the calculated metric of the constituent wire is less than a predetermined amount, current limits in accordance with a respective standard specification are implemented.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable subcombination. In particular, the invention has been described with an identification of each powered device by a class, however this is not meant to be limiting in any way. In an alternative embodiment, all powered device are treated equally, and thus the identification of class with its associated power requirements is not required.

Unless otherwise defined, all technical and scientific terms used herein have the same meanings as are commonly understood by one of ordinary skill in the art to which this invention belongs. Although methods similar or equivalent to those described herein can be used in the practice or testing of the present invention, suitable methods are described herein.

All publications, patent applications, patents, and other references mentioned herein are incorporated by reference in their entirety. In case of conflict, the patent specification, including definitions, will prevail. In addition, the materials, methods, and examples are illustrative only and not intended to be limiting.

In the claims of this application and in the description of the invention, except where the context requires otherwise due to express language or necessary implication, the word “comprise” or variations such as “comprises” or “comprising” is used in any inclusive sense, i.e. to specify the presence of the stated features but not to preclude the presence or addition of further features in various embodiments of the invention.

No admission is made that any reference constitutes prior art. The discussion of the reference states what their author's assert, and the applicants reserve the right to challenge the accuracy and pertinency of the cited documents. It will be clearly understood that, although a number of prior art complications are referred to herein, this reference does not constitute an admission that any of these documents forms part of the common general knowledge in the art in any country

It will be appreciated by persons skilled in the art that the present invention is not limited to what has been particularly shown and described hereinabove. Rather the scope of the present invention is defined by the appended claims and includes both combinations and subcombinations of the various features described hereinabove as well as variations and modifications thereof which would occur to persons skilled in the art upon reading the foregoing description.

I claim:

1. A method of powering a powered device over communication cabling from a power sourcing equipment, the method comprising:
determining the effective resistance between the power sourcing equipment and the powered device;
determining the length of the communication cabling connecting the power sourcing equipment and the powered device; and
calculating a metric of the constituent wires of the communication cabling between the power sourcing equipment and the powered device responsive to said determined effective resistance and said determined length.

2. A method of powering according to claim 1, further comprising:
setting at least one current limit value for the power sourcing equipment associated with powering the powered device responsive to said calculated metric.

3. A method according to claim 2, further comprising:
setting at least one initial current limit to a respective standard value, said setting at least one current limit value responsive to said calculated metric adjusting said initial current limit setting.

4. A method according to claim 2, wherein said setting at least one current limit value responsive to said calculated metric is only in the event said determined effective resistance is greater than a predetermined minimum.

5. A method according to claim 2, wherein said setting at least one current limit value responsive to said calculated metric is only in the event said determined length of communication cabling is greater than a predetermined minimum.

6. A method according to claim 2, wherein said setting at least one current limit value responsive to said calculated metric is only in the event said calculated metric is greater than a predetermined minimum.

7. A method according to claim 2, wherein said at least one current limit value set responsive to said calculated metric is selected responsive to a determined cable type associated with said calculated metric.

8. A method according to claim 2, wherein said at least one current limit value responsive to said calculated metric is selected responsive to a maximum allowed current level associated with said calculated cross-sectional metric.

9. A method according to claim 2, wherein said metric of the constituent wires comprises one of a cross-sectional metric, an effective resistance per unit length and a maximum safe current carrying capability.

10. A method of powering according to claim 1, further comprising:
powering the powered device from the power sourcing equipment responsive said calculated metric of the constituent wires.

11. A system for providing power over communication cabling, the system comprising:
a power sourcing equipment arranged to provide power for a powered device connected to said power sourcing equipment via a communication cabling;
an effective resistance determining functionality in communication with said power sourcing equipment and operative to determine the effective resistance of the communication cabling connecting said power sourcing equipment to the powered device; and
a communication cabling length determining functionality in communication with said power sourcing equipment and operative to determine the length of the communication cabling connecting said power sourcing equipment to the powered device;
said power sourcing equipment being operative to:
calculate, responsive to said determined effective resistance and length of communication cabling, a metric of the constituent wires of the communication cabling connecting said power sourcing equipment to the powered device.

12. A system according to claim 11, wherein said power sourcing equipment is further operative to:
set at least one current limit value for providing power to the powered device from the power sourcing equipment responsive to said calculated metric.

13. A system according to claim 12, wherein said power sourcing equipment is further operative to:
set at least one initial current limit to a respective standard value, said setting of said at least one current limit value responsive to said calculated metric adjusting said initial current limit setting.

14. A system according to claim 12, wherein said power sourcing equipment is only operative to set said at least one current limit value responsive to said calculated metric in the event said determined effective resistance is greater than a predetermined minimum.

15. A system according to claim 12, wherein said power sourcing equipment is only operative to set said at least one current limit value responsive to said calculated metric in the event said determined length of communication cabling is greater than a predetermined minimum.

16. A system according to claim 12, wherein said power sourcing equipment is only operative to set said at least one current limit value responsive to said calculated metric in the event said calculated metric is greater than a predetermined minimum.

17. A system according to claim 12, wherein said at least one current limit value responsive to said calculated metric is selected responsive to a determined cable type associated with said calculated metric.

18. A system according to claim 12, wherein said at least one current limit value responsive to said calculated metric is selected responsive to a maximum allowed current level associated with said calculated cross-sectional metric.

19. A system according to claim 12, wherein said calculated metric comprises one of a cross-sectional metric, an effective resistance per unit length and a maximum safe current carrying capability.

20. A system according to claim 11, wherein said power sourcing equipment is further operative to:
power the powered device from the power sourcing equipment responsive to said calculated metric of the constituent wires.
